(19) United States
(12) Patent Application Publication
(10) Pub. No.: US 2013/0152037 A1
(43) Pub. Date: Jun. 13, 2013

(54) COMPUTER AIDED DESIGN SYSTEM AND METHOD

(71) Applicant: ZHENG-YU HE, Shenzhen City (CN)

(72) Inventor: ZHENG-YU HE, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shezhen City (CN)

(21) Appl. No.: 13/487,269

(22) Filed: Jun. 4, 2012

(30) Foreign Application Priority Data
Dec. 9, 2011 (CN) 201110408571.5

(51) Int. Cl. G06F 17/50

(52) U.S. Cl. 716/136; 716/137

(57) ABSTRACT

A computer aided design system comprises an interface creating module, a reference layer setting module, a detecting module and a signing module. The interface module creates a parameter setting interface to select at least one net being composed of a plurality of cline segments, and set a stack distance. The reference layer setting module sets a reference layer for the layer contained the selected net based on the stack distance. The detecting module obtains a projection of the cline segment of the selected net on the reference layer, sets a region corresponding to the cline segment on the reference layer, detects whether the projection extends out of the set region, and generates a signing signal to sign the cline segment when the projection does extend out of the set region. The signing module signs the cline segment according to the sign signal.

### BACKGROUND

1. Technical Field

The present disclosure relates to printed circuit board layout systems, particularly, to checking position between nets and the patterns designed on the board.

2. Description of Related Art

In designing layouts for printed circuit boards (PCBs), the printed circuit board is composed of a plurality of layers. Each layer can be a reference layer to the other adjacent layers. A shape to be filled with copper on the layer is called a pattern. A collection of at least two terminals on the layer connected together are called a net, which may connect with the pattern. The net is composed of at least one copper trace, called a cline segment, connecting to the terminals. In design, a cline segment on a layer and a pattern on the reference layer adjacent to the layer which includes the cline segment must be one to one location relationship. To make sure of that, the user has to manually check whether the cline segment crosses two patterns on the reference layer which is complex and time consuming.

Therefore, there is room for improvement in the art.

### BRIEF DESCRIPTION OF THE FIGURE

Many aspects of the embodiments can be better understood with reference to the following drawings. The components in the drawings are not necessarily drawn to scale, the emphasis instead being placed upon clearly illustrating the principles of the PCB layout system and method thereof. Moreover, in the drawings, like reference numerals designate corresponding parts throughout the several views.

FIG. 1 is a block diagram of a device in accordance with an embodiment.

FIG. 2 is a schematic diagram showing a parameter setting screen window of a computer aided design system of the device of FIG. 1.

FIG. 3 is a schematic diagram of a detecting module of the computer aided design system of the device of FIG. 1.

FIG. 4 is a flowchart of a detecting method in accordance with the embodiment.

FIG. 5 is a flowchart detailing a step of setting the reference layer from the method of FIG. 4 in accordance with the embodiment.

### DETAILED DESCRIPTION

In general, the word “module,” as used herein, refers to logic embodied in hardware or firmware, or to a collection of software instructions, written in a programming language, for example, Java, C, or assembly. One or more software instructions in the modules may be embedded in firmware, such as in an EPROM. Modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage system. Embodiments of the present disclosure will be described with reference to the drawings.

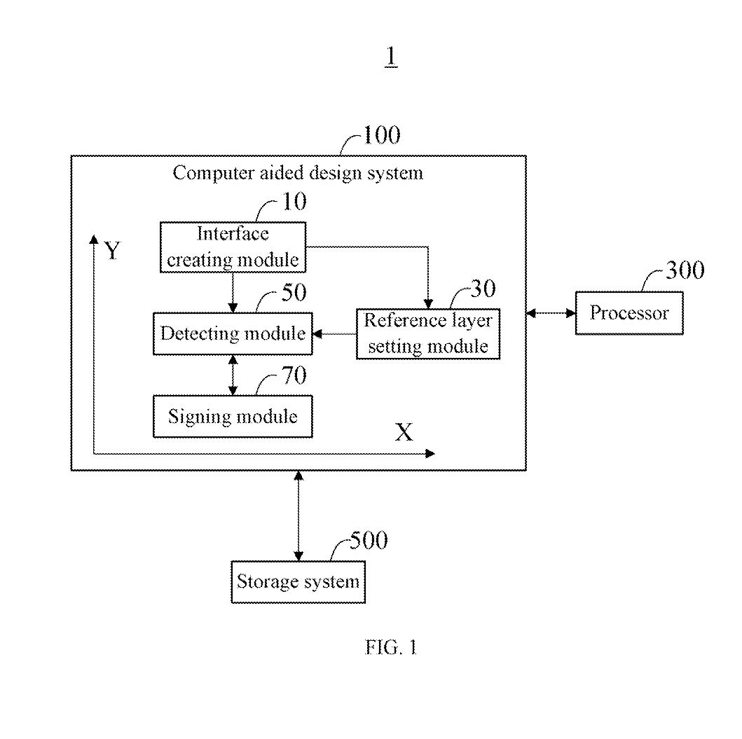

FIG. 1 shows a device 1 such as a computer including a computer aided design system 100, a processor 300 and a storage system 500. The computer aided design system 100 is used for designing a printed board circuit (PCB). The PCB is composed of a plurality of laminated layers unevenly spaced from each other by insulating material. Each layer can be a reference layer to the adjacent layer. A hole penetrating some layers to electrically connect the penetrated layers is called a through hole. A shape filled with copper on the layer is called a pattern. A collection of at least two terminals on the layer connected together is called a net, which may connect with the pattern. The net is composed of a plurality of cline segments. The computer aided design system includes a grid with Cartesian coordinates or XY axes for specifically identifying locations of through holes, patterns and nets in the design.

The computer aided design system 100 includes an interface creating module 10, a reference layer setting module 30, a detecting module 50, and a signing module 70. In the embodiment, the computer aided design system 100 is used in a PCB layout system to select nets on the design, set parameters, obtain a reference layer based on the set parameters, obtain a projection of the detected cline segment on the reference layer, and set a region corresponding to the detected cline segment on the reference layer. The computer aided design system 100 further detects whether the projection extends out of the set region and signs or marks appropriately upon detecting that a projection does extend out of the set region. The modules 10-70 may comprise computerized code in the form of one or more programs that are stored in the storage system 500. The computerized code includes instructions that are executed by the at least one processor to provide functions for modules 10-70.

The processor 300 executes one or more computerized codes of the device 1 and other applications, to provide the functions of the device 1.

The storage system 500 may be a memory system of the device 1, and also may be an external storage card, such as a smart media (SM) card, or secure digital (SD) card, for example. The storage system 500 stores the coordinates of each through hole, the coordinates of nets, and the coordinates of cline segments.

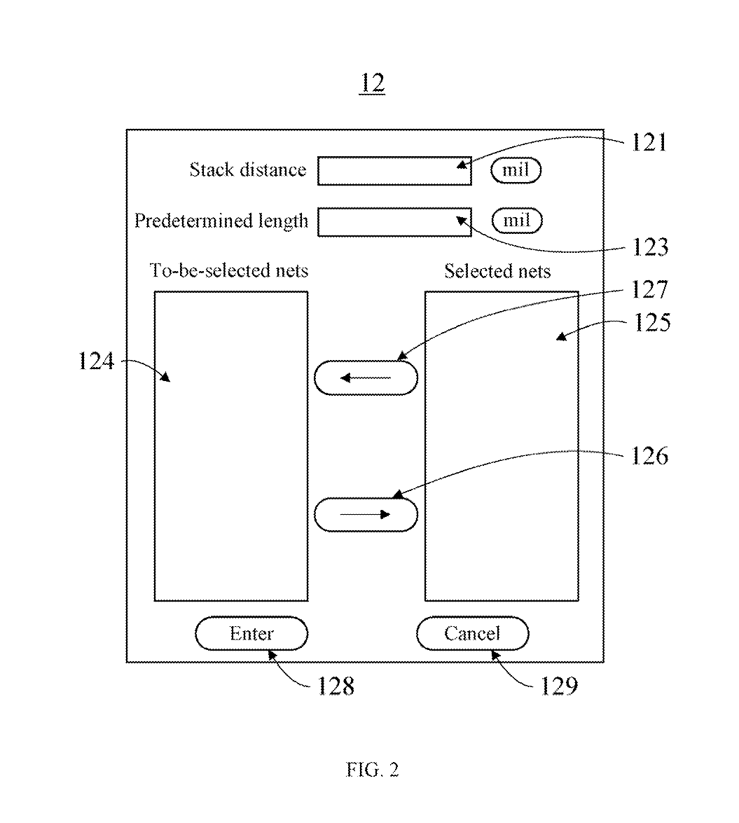

As shown in FIG. 2, the interface creating module 10 provides a parameter setting interface 12 on the screen (not shown) of the device 1, by which the user can choose the to-be-checked nets and set the parameters. The parameters applied to the selected nets include a stack distance for setting a reference layer of the current layer, and a predetermined length for obtaining a point on the cline segment. In the embodiment, the parameter setting interface 12 includes a stack distance setting box 121, a predetermined length setting box 123, a to-be-selected net displaying box 124, a selected net displaying box 125, an add button 126, a delete button 127, an enter button 128 and a cancel button 129. The stack distance setting box 121 is used for setting the value of a stack distance. The predetermined length setting box 123 is used for setting a value of the predetermined length which is more than the least distance between two patterns. The to-be-selected net displaying box 124 is used for displaying the names of the to-be-selected nets of the PCB layout design. The selected net displaying box 125 is used for displaying the names of the selected net of the PCB layout design. When the add button 126 is clicked, the name of the selected net in the to-be-selected net displaying box 124 is added to and displayed in the selected net displaying box 125. When the delete button 126 is clicked, the name of the selected net in the selected net displaying box 125 is moved to the to-be-selected net displaying box 124. When the enter button 128 is clicked, the stack distance and the name of the selected nets in the selected net displaying box 125 are transmitted to the reference layer setting module 30, and the predetermined length and the names of the selected nets are transmitted to the detecting module 50. When the cancel button 208 is clicked, the parameter setting interface 12 exits.

The reference layer setting module 30 sets the reference layer for the net currently being analyzed based on the stack distance, and further transmits the set information of the reference layer to the detecting module 50. When the current layer is the inner layer of the PCB, the reference layer setting module 30 calculates the distance between the current layer and the two adjacent layers of the current layer, and further calculates the absolute value of any difference between the two calculated distances. The reference layer setting module 30 further compares the absolute value with the stack distance. When the absolute value is larger than the stack distance, the reference layer setting module 30 sets the nearer adjacent layer as the reference layer for the layer contained the selected net. When the absolute value is within the stack distance, the reference layer setting module 30 sets the two adjacent layers of the current layer as a first reference layer and a second reference layer for the layer contained the selected net. In the embodiment, the stack distance is 0 mil.

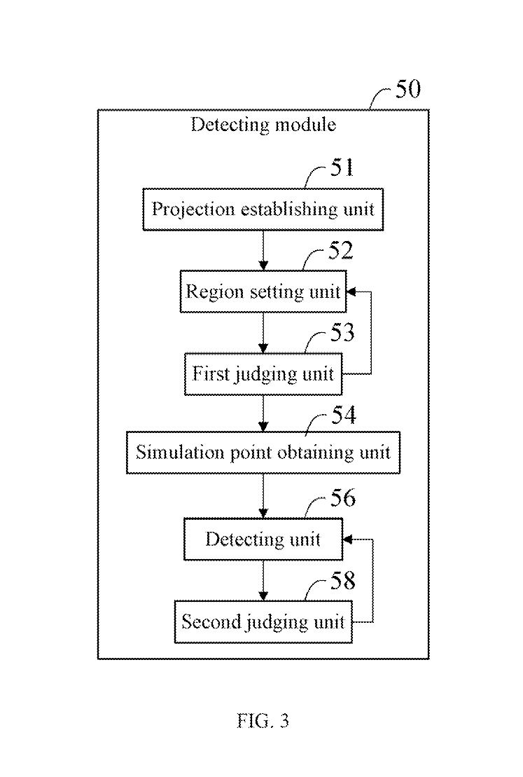

The detecting module 50 obtains, in relation to the cline segment under detection, a projection of the cline segment of the selected net on the reference layer, sets a region on the reference layer, and further detects whether the obtained projection extends out of the set region. Referring to FIG. 3, the detecting module 50 includes a projection setting unit 51, a region setting unit 52, a first judging unit 53, a simulation point obtaining unit 54, a detecting unit 56, and a second judging unit 58.

The projection establishing unit 51 establishes the projection of the selected net and sets a beginning point and an ending point which are the two ends of the projection of the selected net under detection.

The region setting unit 52 sets a first region corresponding to the detected cline segment on the reference layer. In the embodiment, the first region is the pattern where one end of the projection of the cline segment is contained.

The first judging unit 53 judges whether the cline segment is connected to a through hole and generates a setting signal when the cline segment is connected to a through hole.

The region setting unit 52 further sets a second region on the reference layer according to the setting signal. In the embodiment, the second region is an insulated region on the reference layer which contained the projection of the connected through hole.

The simulation point obtaining unit 54 obtains a plurality of simulation points of the obtained projection based on the predetermined length. The simulation points include the two ends of the obtained projection and the points spaced from each other in a predetermined length from one end of the obtained projection to the other end of the obtained projection. In the embodiment, the simulation point obtaining unit 54 includes at least two simulation points, and the predetermined length is 5 mil.

The detecting unit 56 detects whether the simulation point extends out of the set region and generates a signing signal to sign the cline segment when the simulation point extends out of the set region. In the embodiment, when the set region includes the first region and the second region, the detecting unit 56 firstly detects whether the simulation point extends out of the first region; when the simulation point does extend out of the first region, the detecting unit 56 further detects whether the simulation point extends out of the second region, if the simulation point extends out of the second region, the detecting unit 56 generates a signing signal.

The second judging unit 58 determines whether the simulation point is the ending point and completes the detecting process of the detecting selected net when the simulation point is in fact the ending point.

The signing module 70 signs the cline segment according to the signing signal. In the embodiment, the signing module 70 signs the cline segment by means of highlighting and marks the layer which includes the cline segment according to the signing signal.

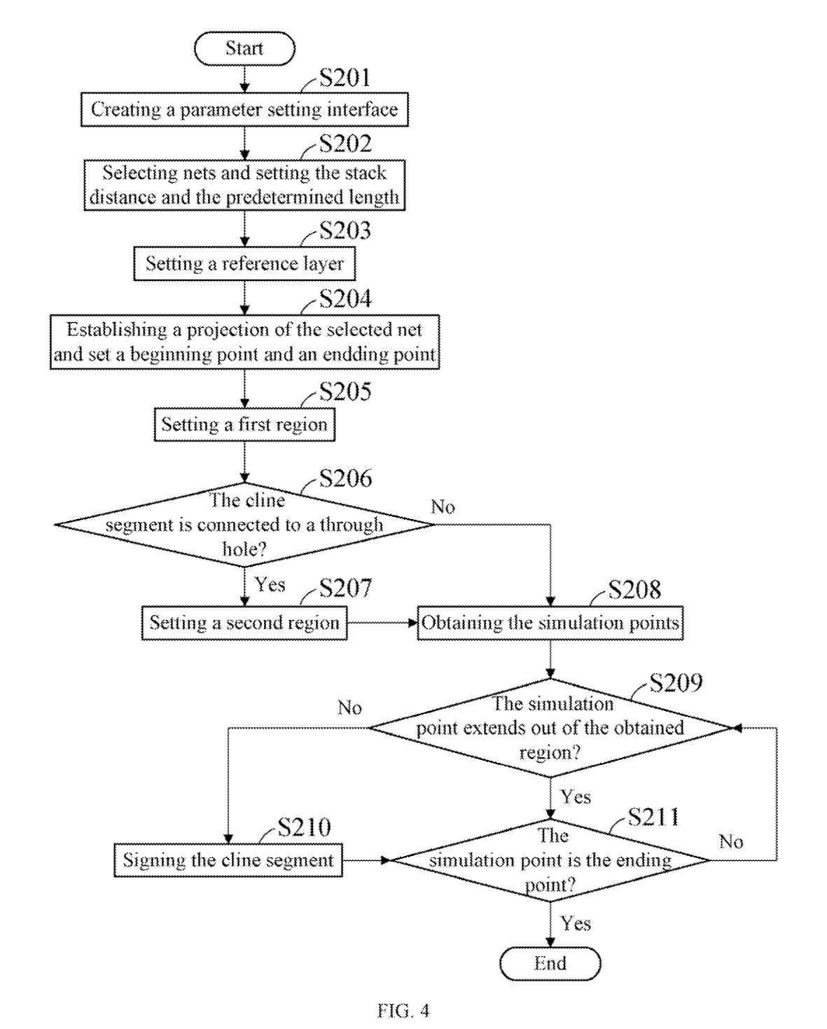

Referring to FIG. 4, a detecting method is used for selecting nets on a design, setting parameters, obtaining a reference layer based on the set parameters, establishing projections of the cline segments of the selected net on the reference layer, setting a region for each projection on the reference layer, and detect whether the projections extends out of the corresponding set region. The PCB is composed of a plurality of laminated layers unevenly spaced from each other by the insulating material. The detecting method includes the following steps.

In step S201, the interface creating module creates a parameter setting interface 12 for setting the parameters. In the embodiment, the parameters for the selected nets include a stack distance between the current layer and the adjacent layer of the current layer, and a predetermined length. The parameter setting interface 12 includes a stack distance setting box 121, a predetermined length setting box 123, a to-be-selected net displaying box 124, a selected net displaying box 125, an add button 126, a delete button 127, an enter button 128 and a cancel button 129. The stack distance setting box 121 is used for setting the value of a stack distance. The predetermined length setting box 123 is used for setting the value of the predetermined length. The to-be-selected net displaying box 124 is used for displaying the names of the to-be-selected nets of the PCB layout design. The selected net displaying box 125 is used for displaying the name of the selected net of the PCB layout design.

In step S202, the interface creating module 10 selects the nets and sets the stack distance and the predetermined length in the parameter setting interface 12 in response to the user's operation. In the embodiment, when the add button 126 is clicked, the name of the selected net in the to-be-selected net displaying box 124 is added to and displayed in the selected net displaying box 125. When the delete button 126 is clicked, the name of the selected net in the selected net displaying box 125 is moved to the to-be-selected net displaying box 124. When the enter button 128 is clicked, the stack distance and the name of the selected nets in the selected net displaying box 125 are transmitted to the reference layer setting module 30, and the predetermined length and the names of the selected nets are transmitted to the detecting module 50. When the cancel button 208 is clicked, the parameter setting interface 12 exits.

In step S203, the reference layer setting module 30 sets the reference layer for the currently analyzed net based on the stack distance, and further transmits the set information of the reference layer to the detecting module 50. When the current layer is the inner layer of the PCB, the reference layer setting module 30 calculates the distance between the current layer and the two adjacent layers of the current layer, and further calculates the absolute value of any difference between the two calculated distances. The reference layer setting module 30 further compares the absolute value with the stack distance. When the absolute value is larger than the stack distance, the reference layer setting module 30 sets the nearer adjacent layer of the current layer as the reference layer. When the absolute value is within the stack distance, the reference layer setting module 30 sets the two adjacent layers of the current layer as a first reference layer and a second reference layer. In the embodiment, the stack distance is 0 mil.

In step S204, the projection establishing unit 51 establishes, in relation to the cline segment under detection, a projection of the cline segment, and sets a beginning point and an ending point which are the two ends of the projection of the selected net under detection.

In step S205, the region setting unit 52 sets a first region on the reference layer. In the embodiment, the first region is the pattern where one end of the projection of the cline segment is contained.

In step S206, the first judging unit 53 determines whether the cline segment is connected to a through hole. If the cline segment is connected to a through hole, the procedure goes to S207; if the cline segment is not connected to a through hole, the procedure goes to S208.

In step S207, the region setting unit 52 sets a second region on the reference layer according to the setting signal. In the embodiment, the second region is an insulated region on the reference layer which contained the projection of the connected through hole.

In step S208, the simulation point obtaining unit 54 obtains a plurality of simulation points of the obtained projection based on the predetermined length. The simulation points include the two ends of the obtained projection and the points spaced from each other in a predetermined length from one end of the obtained projection to the other end of the obtained projection. In the embodiment, the simulation point obtaining unit 54 includes at least two simulation points, and the predetermined length is 5 mil.

In step S209, the detecting unit 56 detects whether the simulation point extends out of the set region. If the simulation point does extend out of the set region, the procedure goes to S210; if the simulation point does not extend out of the set region, the procedure goes to S211. In the embodiment, when the set region includes the first region and the second region, the detecting unit 56 firstly detects whether the simulation point extends out of the first region; when the simulation point does extends out of the first region, the detecting unit 56 further detects whether the simulation point extends out of the second region, if the simulation point does extends out of the second region, the detecting unit 56 generates a signing signal to sign the cline segment.

In step S210, the signing module 70 signs the cline segment according to the signing signal and the procedure goes to S211. In the embodiment, the signing module 70 signs the cline segment by means of highlighting and mark the layer which includes the cline segment according to the signing signal.

In step S211, the second judging unit 58 judges whether the simulation point is the ending point. If the simulation point is not the ending point, the procedure goes to step S209; if the simulation point is the ending point, the detecting process of the current detecting selected is accomplished and the procedure ends.

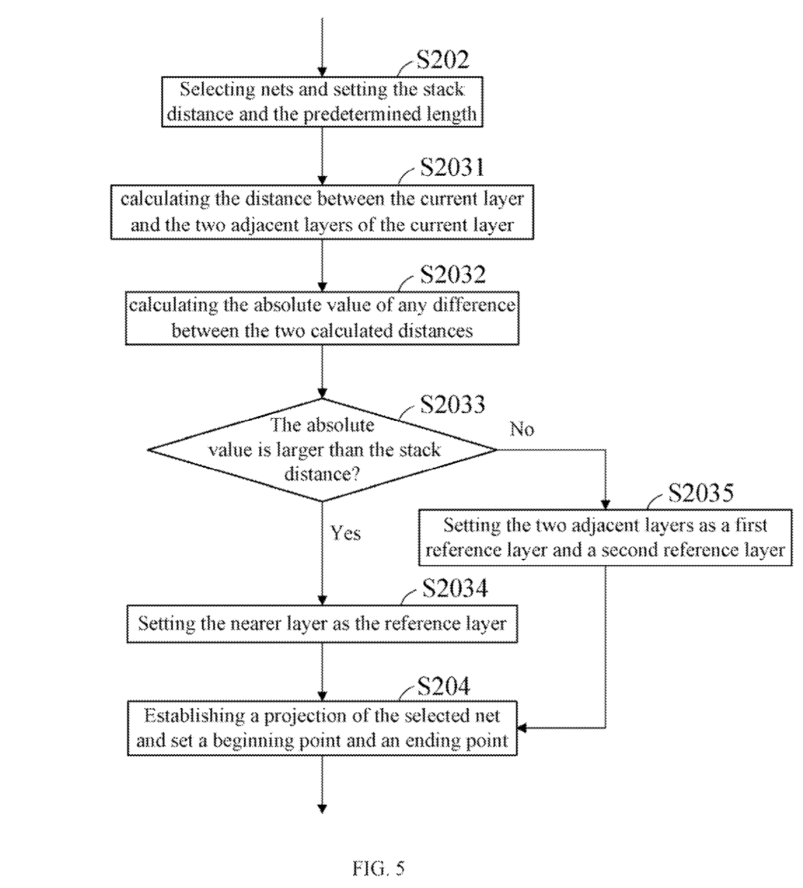

In the embodiment, when the selected net is disposed on an inner layer of the PCB, step S203 further comprises the following steps(shown in FIG. 5).

In step S2031, the reference layer setting module 30 calculates the distance between the current layer of the current selected net and the two layers adjacent to the current layer.

In step S2032, the reference layer setting module 30 calculates the absolute value of any difference between the two calculated distances.

In step S2033, the reference layer setting module 30 compares the absolute value with the stack distance. If the absolute value is larger than the stack distance, the procedure goes to S2034; if the absolute value is within the stack distance, the procedure goes to S2035.

In step S2034, the reference layer setting module 30 sets the nearer adjacent layer as the reference layer for the layer contained the selected net, then the procedure goes to S204.

In step S2035, the reference layer setting module 30 sets the two adjacent layers of the current layer as the first reference layer and the second reference layer for the layer contained the selected net, then the procedure goes to S204.

In use, the one to one location relationship between a cline segment on a layer and a pattern on the reference layer adjacent to the layer which includes the cline segment are automatically detected by the computer and marked, such that the detecting operation becomes simpler and saves time.

While various exemplary embodiments have been described, the disclosure is not to be limited thereto. Various modifications and similar arrangements (as would be apparent to those skilled in the art) are also intended to be covered. Therefore, the scope of the appended claims should be accorded the broadest interpretation so as to encompass all such modifications and similar arrangements.

What is claimed is:

1. A computer aided design system of a device used in a printed circuit board layout system, the device comprises at least one processor and a storage system to store a contact list and one or more network applications; the computer aided design system includes one or more programs and displays a printed circuit board with a plurality of layers which comprises a plurality of through holes, patterns, and nets, the one or more programs stored in the storage system and executable by the at least one processor, the one or more programs comprising:
an interface creating module configured to create a parameter setting interface on a screen of the device for selecting at least one net which is being composed of a plurality of cline segments, and setting parameters which includes a stack distance for setting a reference layer for one of the plurality of layers which contained the selected net;
a reference layer setting module configured to set a reference layer for the layer containing the selected net based on the stack distance;
a detecting module configured to obtain a region corresponding to the cline segment on the reference layer, and detect whether the cline segment extends out of the set region, and generate a sign signal to sign the cline segment when the cline segment does extend out of the set region; and
a signing module configured to sign the cline segment according to the signing signal.

2. The computer aided design system of claim 1, wherein the parameters further comprises a predetermined length for obtaining a point on the cline segment of the selected net; the detecting module comprises a projection establishing unit, a simulation obtaining unit, and a detecting unit; the projection establishing unit obtains a projection of the selected net on the reference layer; the simulation point obtaining unit established a plurality of simulation points of the projection of the cline segment based on the predetermined length; the detecting unit detects whether the simulation point extends out of the set region, and generates a signing signal when the simulation point does extend out of the set region.

3. The computer aided design system of claim 2, wherein the simulation point includes the two ends of the cline segment and the points spaced from each other in the predetermined length from one end of the cline segment to the other end of the cline segment.

4. The computer aided design system of claim 2, wherein the detecting module further comprises a region setting unit; the region setting unit sets a first region which is a pattern contained one end of the projection of the cline segment.

5. The computer aided design system of claim 4, wherein the detecting module further comprises a first judging unit; the first judging unit determines whether the cline segment is connected to a through hole and generates a setting signal when the cline segment is connected to a through hole, the region setting unit further sets a second region which is an insulated region on the reference layer which is contained the projection of the connected through hole.

6. The computer aided design system of claim 3, wherein the detecting module further comprises a second judging unit; the projection establishing unit further sets a beginning point and an ending point which are the two ends of the current selected net; the second judging unit judges whether the simulation point is the ending point and completes the detecting process of the current selected net when the simulation point is in fact the ending point.

7. The computer aided design system of claim 1, wherein the selected net is set on the inner layer of the printed circuit board, the reference layer setting unit calculates the distance between the current layer of the selected net and the two adjacent layers of the current layer, further calculates a absolute value of any difference between the two calculated distances, and sets the reference layer based on the compared result of the absolute value and the stack distance.

8. The computer aided design system of claim 7, wherein when the absolute value is larger than the stack distance, the reference layer setting unit set the nearer adjacent layer as the reference layer for the layer contained the selected net.

9. The computer aided design system of claim 7, wherein when the absolute value is within the stack distance, the reference layer setting unit sets the two adjacent layer of the current layer as a first reference layer and a second reference layer for the layer contained the selected net.

10. The computer aided design system of claim 2, wherein the predetermined length is more than the least distance between two patterns.

11. A detecting method for a computer aided design system of a device in a printed circuit board layout with a plurality of layers which comprises a plurality of through holes, patterns, and nets, the computer aided design system capable of executed by a processor to perform instructions stored in a storage system, the device comprising one or more network applications and a contact list; the checking method comprising:
creating a parameter setting interface on the screen of the device and displaying a design with a plurality of nets which is being composed of a plurality of cline segments;
selecting at least one net of the design which is being composed of a plurality of cline segments, and setting parameters which comprises a stack distance for setting a reference layer of a layer contained the selected net;
setting a reference layer for the layer containing the selected net based on the stack distance;
setting a region corresponding to the cline segment on the reference layer;
detecting whether the cline segment extends out of the set region;
generating a signing signal when the cline segment does extend out of the set region; and
signing the cline segment according to the signing signal.

12. The method according to claim 11, wherein the parameters further comprises a predetermined length for obtaining a point on the cline segment of the selected net, the step of detecting whether the cline segment extends out of the set region further comprising:
obtaining a projection of the cline segment on the reference layer and setting a beginning point and an ending point which are the two ends of the selected net;
establishing a plurality of simulation points of the projection of the cline segment based on the predetermined length; and
detecting whether the simulation point extends out of the set region

13. The method according to claim 12, wherein the simulation points includes the two ends of the operation of the cline segment and the points spaced from each other in the predetermined length from one end of the projection of the cline segment to the other end of the projection of the cline segment.

14. The method according to claim 12, wherein the step of setting a region corresponding to the cline segment on the reference layer further comprising:
setting a first region on the reference layer which is a pattern contained one end of the projection of the cline segment.

15. The method according to claim 14, wherein the step of setting a first region on the reference layer which is a pattern which contained one end of the projection of the cline segment further comprising:
judging whether the cline segment is connected to a through hole and generating a setting signal when the cline segment is connected to a through hole; and
setting a second region on the reference layer which is an insulated region on the reference layer which contained the projection of the connected through hole.

16. The method according to claim 15, wherein after the step of signing the cline segment according to the signing signal further comprising:
determining whether the simulation point is the ending point; and
completing the process when the simulation point is in fact the ending point.

17. The method according to claim 14, wherein when the selected net is on the inner layer of the print circuit board, the step of setting a reference layer for the layer contained the selected layer based on the stack distance further comprising:
calculating the distance between the current layer of the selected net and the two adjacent layers of the current layer;
calculating a absolute value of any difference between the two calculated distances; and
comparing the absolute value with the stack distance.

18. The method according to claim 17, wherein when the absolute value is larger than the stack distance, the reference layer setting unit set the nearer adjacent layer as the reference layer for the layer contained the selected net.

19. The method according to claim 17, wherein when the absolute value is within the stack distance, the reference layer setting unit set the two adjacent layers of the current layer as a first reference layer and a second reference layer for the layer contained the selected net.

20. The method according to claim 12, wherein the predetermined length is more than the least distance between two patterns.
